(19) United States
(12) Patent Application Publication
(10) Pub. No.: US 2023/0360121 A1
(43) Pub. Date: Nov. 9, 2023

(54) SYSTEMS AND METHODS FOR AUTOMATED ANALYSIS OF BANK AND/OR TRANSACTION INFORMATION

(71) Applicant: LOKYATA, INC., North Royalton, OH (US)

(72) Inventors: Stephen BIRELEY, CULPEPER, VA (US); Qing CHEN, MCLEAN, VA (US); Tommy EASTMAN, CANDLER, NC (US); Daniel CITBAJ, Vienna (AT)

(21) Appl. No.: 18/311,871

(22) Filed: May 3, 2023

Related U.S. Application Data
(60) Provisional application No. 63/337,795, filed on May 3, 2022.

(51) Int. Cl. G06Q 40/03

(52) U.S. Cl. CPC G06Q 40/03

(57) ABSTRACT

An example computer implemented method can include generating feature data based on categorizing and tagging respective transactions in transaction description data, in which the feature data includes category tags specifying respective categories of discrete features and aggregated features for transactions. Each category tag defines a respective variable of a scoring model, and each respective variable has at least one value representative of a respective discrete or aggregated feature based on the transaction description data. The method can also include applying rules to the feature data to provide a first hierarchical decision, in which the rules represent underwriting criteria. The method can also include applying the scoring model to process the feature data and compute a score having a value representing a credit worthiness and/or a likelihood of loan default by the borrower and providing a second hierarchical decision.

### RELATED APPLICATIONS

This application claims the benefit of priority to U.S. Provisional Patent Application No. 63/337,795, filed May 3, 2022, and entitled AUTOMATED BANK VERIFICATION AND/OR TRANSACTION ANALYZER, which is incorporated herein by reference in its entirety.

### TECHNICAL FIELD

This disclosure relates to systems and methods for automated analysis of bank and/or transaction information, such as to facilitate credit decisioning.

### BACKGROUND

Making a decision to extend credit to a potential borrower is a complex process that is based on the accuracy of many interdependent variables. The decision becomes more complicated for individuals and entities that do not have a satisfactory credit rating or credit history, particularly in the context of subprime lending. Subprime refers to the credit quality of particular borrowers, who typically have weakened credit histories and may present a greater risk of loan default than prime borrowers.

### SUMMARY

This disclosure relates to systems and methods for automated analysis of bank and/or transaction information, such as to facilitate credit decisioning.

An example computer implemented method can include generating feature data based on categorizing and tagging respective transactions in transaction description data, in which the feature data includes category tags specifying respective categories of discrete features and aggregated features for transactions. Each category tag defines a respective variable of a scoring model, and each respective variable has at least one value representative of a respective discrete or aggregated feature based on the transaction description data. The method can also include applying rules to the feature data to provide a first hierarchical decision, in which the rules represent underwriting criteria. The first hierarchical decision can represent an automatic denial or enable further decision processing. The method can also include applying the scoring model to process the feature data and compute a score having a value representing a credit worthiness and/or a likelihood of loan default by the borrower and providing a second hierarchical decision.

As another example, a system includes one or more non-transitory machine-readable media storing data and instructions. One or more processors are configured to access the media and execute the instructions to generate feature data based on categorizing and tagging respective transactions in transaction description data, in which transaction description data includes information describing a plurality of financial transactions of a borrower over at least one time interval recorded by at least one financial institution. The feature data also includes category tags specifying respective categories of discrete features and aggregated features for each transaction, at least one category tag defines a respective variable of a scoring model, in which each respective variable has at least one value representative of a respective discrete or aggregated feature based on the transaction description data. The processor can be further programmed to analyze the feature data. The analyzing can include applying rules to the feature data to provide a first hierarchical decision, in which the rules describe a set of underwriting criteria and the first hierarchical decision represents an automatic denial or enabling further processing by the scoring model. Additionally, or alternatively, the analyzing can include applying the scoring model to process the feature data and compute a score having a value representing a credit worthiness and/or a likelihood of loan default by the borrower.

### BRIEF DESCRIPTION OF THE DRAWINGS

FIG. 1 depicts an example system for transaction analysis and credit decisioning.

FIG. 2 depicts an example of an income identification function.

FIG. 3 depicts an example of a debt identification function.

FIG. 4 depicts an example of part of a transaction description data prior to tagging.

FIG. 5 depicts an example of the transcription description data from FIG. 4 after performing tagging.

FIG. 6 depicts an example of a structure for a scoring model.

FIG. 7 depicts an example of a scoring variable that can be used in the scoring model of FIG. 5.

FIG. 8 depicts an example of a GUI configured to provide an overview of decision results and categorized feature data.

FIG. 9 depicts an example GUI configured to provide respective indicators.

FIG. 10 is an example GUI configured to provide one or more of the rules.

FIG. 11 depicts an example transaction GUI for changing one or more category tags.

FIG. 12 depicts an example GUI showing a list of pending category tag changes.

FIG. 13 depicts an example GUI that includes an interactive list of one or more category tag changes pending review.

FIGS. 14 and 15 show examples of GUIs configured to provide an overview of decision results and categorized feature data.

FIGS. 16 and 17 show further examples of GUIs to provide interactive visualizations of score/decision data.

### DETAILED DESCRIPTION

This disclosure relates to systems and methods for automated analysis of bank and/or transaction information, such as to facilitate credit decisioning. The systems and methods are programmed to perform automated transaction verification and/or credit decisioning of a prospective borrower (also referred to as a credit applicant, applicant or customer). For example, the systems and methods described herein implement computer code (e.g., functions and methods), including artificial intelligence, programmed to analyze financial transactions of a borrower over time and determine a likelihood (e.g., provided as a score) that the borrower will repay a loan or other credit obligation. The systems and methods thus provide a powerful analysis tool that can be used by a lender, such as a bank or other financial institution, or by any business that could benefit from understanding financial transactions (e.g., contained in bank statements) of an applicant. The systems and methods described herein are particularly useful to assess the financial health and/or credit worthiness (or credit risk) of borrowers who are considered near-prime, sub-prime or thin-file applicants.

As described herein, the systems and methods include machine-readable instructions, which are executable by one or more processors to perform various analysis and decisioning functions. The systems and methods described herein can be implemented as a service (e.g., software as a service, such as cloud computing) or other form of software program (on premise software). For example, the instructions include accessing transaction description data of a borrower, such as a person or entity applying for credit or a loan. The transaction description data can include information describing a plurality of financial transactions of the borrower over one or more time intervals, such as recorded by one or more financial institutions (e.g., recorded in the borrower's financial statements).

The systems and methods are also programmed to generate feature data based on categorizing and tagging respective transactions in the transaction description data. The feature data can include category tags specifying respective categories of discrete borrower transaction features. The feature data can also include category tags to specify aggregated borrower transaction features, which are derived from analyzing multiple related transactions over time. Each category tag can define a respective variable of a scoring model (e.g., a machine learning model), and each respective variable has at least one value representative of a respective discrete or aggregated feature based on the transaction description data.

The systems and methods further can include instructions programmed to apply rules to the feature data and provide a first hierarchical decision. The first hierarchical decision can be based on execution of a rule set, which may be customized to align with underwriting criteria used by the lender. For instance, the first hierarchical decision can represent an automatic denial for the borrower or enable further consideration and processing based on the scoring model. The scoring model can be applied to process the transaction and feature data and compute a score having a value representing the credit worthiness and/or likelihood of loan default by the borrower. The score can provide a second hierarchical decision, which can be a recommendation to deny or approve the borrower or flag the borrower for further review by the user (e.g., an agent). The systems and methods can include an interactive graphical user interface (GUI) that provides one or more automated recommendations (e.g., in a report) based on the analysis scoring model. A user can approve or decline one or more recommendations presented in the GUI by entering instructions through the GUI.

The analysis and actionable information provided by the systems and methods can be implemented by a user (e.g., an agent of a lender or other business) once for a given borrower. Additionally, or alternatively, the transaction data can continue to be collected and analyzed after an initial decision and provide actionable data to indicate a change in circumstances that could affect (or alter) the original assessment. In this way, a user can use the systems and methods (e.g., as part of a monitoring program) to generate reports periodically or intermittently during the life of a loan (or other ongoing financial obligation) and to stay ahead of possible collection issues for the given borrower.

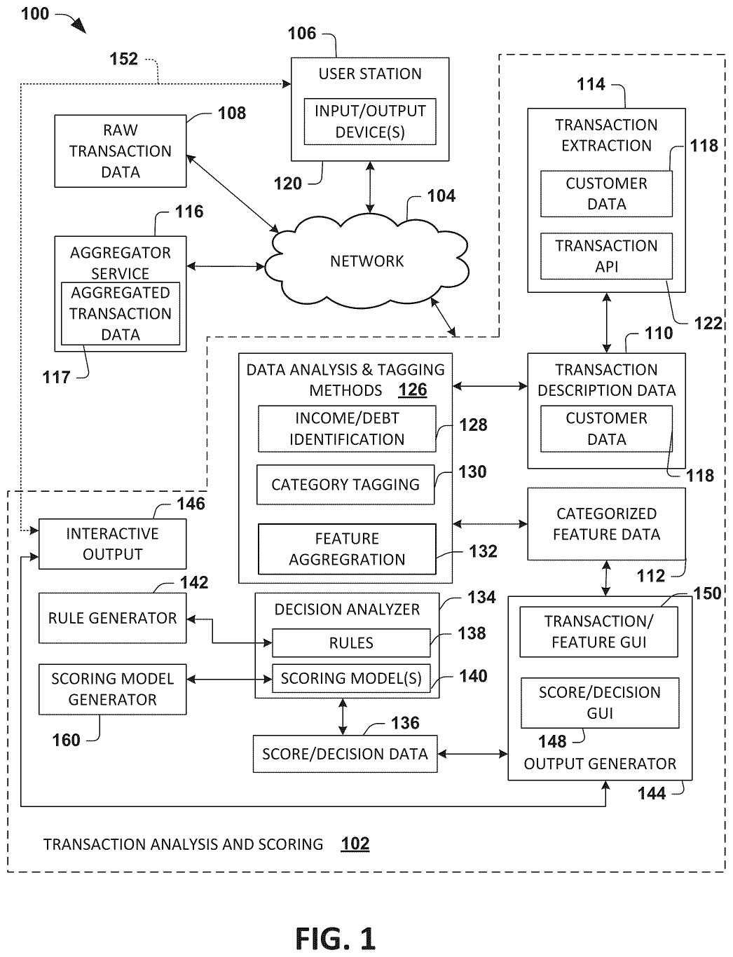

FIG. 1 depicts an example system 100 configured to implement transaction analysis to facilitate credit decisioning. The system 100 includes a transaction analysis and scoring system (TASS) 102. The TASS 102 includes data and instructions executable by one or more processors configured to perform automated transaction verification and/or credit decisioning, as described herein. The TASS 102 can be implemented as software as a service (SAAS) using cloud computing resources, as on-premise software, or as instructions distributed across any number of devices on premise and/or in a computing cloud. In the example of FIG. 1, the TASS 102 is coupled to a network 104, such as a wide area network (WAN) (e.g., the Internet), a local area network (LAN) or another network or combination of network topologies. One or more user stations 106, such as a computer or other processor-based device, are endpoints in the system 100 coupled to the network 104 and configured to use the TASS 102 through the network. In other examples, the TASS 102 or a portion thereof is resident on the user station 106.

The user station 106 can be coupled to the TASS over a secure communication link (e.g., using transport layer security (TLS), secure sockets layer (SSL) and/or another secure protocol). Each user, such as an agent of a lender, can be authenticated by the TASS 102 to access one or more functions of the TASS 102. Each users' access can vary according to the user's role, such as by using role-based certificates for user authentication with the TASS 102. The type of security and/or encryption used is generally outside of the scope of this disclosure, and those skilled in the art will understand one or more security measures that can be implemented to increase security for a given application.

The system 100 can also include (and/or use) one or more sources of raw transaction data, shown at 108. For example, each source of raw transaction data 108 stores records of transactions that occurred for a number of customers, which can include consumers or other entities. The categorization and labeling for each transaction are not standardized among institutions. Additionally, the categorization and labeling tend to be limited to discrete transactions, which tends to provide limited actionable insight. As used herein, the term transaction refers to an economic event with another party or entity that is recorded in the transaction data 108, which can be maintained by a bank or other institution. There are many categories that can be used to describe different types of transactions, including credits and debits. Each institution can use various unique naming conventions to label a given transaction. As an example, a given transaction can be categorized as debt settlement, gambling gaming, loan disbursement, loan payment, insufficient funds, overdraft protection, pawnshop, pay advance, other expense, transfer, withdrawal, cash advance, deposit, income, charges and other expense or deposit. There can be other categories of transactions stored in the raw transaction data 108 in other examples.

The TASS 102 is also configured to access transaction description data 110, which can be stored in memory (e.g., locally or remotely), such as a data repository or other data. The transaction description data 110 includes information describing a plurality of financial transactions recorded by at least one financial institution over one or more time intervals. In an example, the transaction description data 110 includes descriptions or labels that have been assigned to respective transactions. As described below, the TASS 102 is configured to analyze the transaction description data 110 and perform data enrichment to provide categorized feature data 112, which has been enriched to include category tags that characterize discrete transactions and other category tags to describe aggregated transaction features that can be determined from an evaluation of multiple related discrete transactions. As used herein, a feature or a feature transaction can refer to a discrete transaction as well as to a characterization of or calculation derived from multiple discrete transactions.

In some examples, the TASS 102 includes a transaction extraction method 114 programmed to provide the transcription description data 110 for a given borrower based on the raw transaction data 108 for the given borrower. As described herein, the raw transaction data 108 can be from one or more sources of borrower transactions. For example, the sources of transactions can include one or more checking accounts, savings accounts, investment accounts, credit card accounts, mortgage accounts, and the like. The transaction extraction method 114 can be configured to access the raw transaction data directly or through one or more third party services, such as shown as aggregator service 116, based on customer data 118 and responsive to a lender-user request to retrieve customer transaction information. The lender request can be entered at a user input/output device 120 of the user station 106 (e.g., a mouse, keyboard, touch screen, etc.). The aggregator service 116 is coupled to the network 104 and thus can access the raw transaction data 104 through the network 104 responsive to the lender-user request.

For example, the transaction extraction method 114 includes a transaction application programming interface (API) programmed to request a borrower's financial transaction data through the data aggregator service 116 based on customer data 118 and in response to the lender-user request. The API 122 and/or customer data 118 can include information to enable the aggregator service 116 to access the borrower's financial transaction data 108 from a number of sources. The customer data 118 can also include other information provided by the borrower that is to be verified (e.g., by the TASS 102) as part of the process, such as income, loan obligations, employer name, cash flow, and the like. In an example, the customer data 118 includes customer account and access information (e.g., account number(s), username(s) and password(s)) or provide resource locations (e.g., links) or other means to enable the borrower to provide the data aggregator 116 access to the borrower's accounts. In other examples, no customer identification and/or access information is stored or used directly by the TASS 102, and a token-based authentication protocol can be implemented by the aggregator service 116 to provide requisite access information for the borrower, such as through a token or other credentialed access mechanisms, helping further to maintain confidentiality and security for the borrower and the borrower's accounts. For instance, all financial and customer data for a given borrower can be identified and linked within the TASS 102 by a unique user identifier, such as a loan number or other identifier associated with the loan number and/or the borrower.

The data aggregator service 116 thus can be programmed to collect aggregated transaction data for the borrower, shown at 117, from any number of sources of the transaction data 108 responsive to the API 122 (e.g., a secure token-based API). The aggregator service 116 can provide the aggregated transaction data 117 to include some descriptive categories or labels for respective transactions (e.g., transaction metadata). The aggregated transaction data can be provided according to the JavaScript Object Notation (JSON) format or in another data format. The descriptive categories or labels that are included in the aggregated transaction data 117 can include descriptions included as part of the raw transaction data 108. As another, or alternative example, the aggregator service 116 can add descriptive categories or labels (e.g., transaction metadata) to transaction events and/or remove extraneous information from the records to provide the aggregated transaction data 117 can include cleansed and actionable financial information. The aggregator service 116 thus can return the aggregated transaction data 117 to the transaction extraction method 114 through the API 122, and the transaction extraction method 114 can store the returned transaction data for the borrower as part of the transaction description data 110 associated with the borrower. The transaction extraction method 114 can also store certain to-be-verified customer data 118, which may be provided by the borrower (e.g., income, existing loan obligations, employer name, cash flow, and the like) to the lender, as part of the application process.

The TASS 102 also includes data analysis and tagging methods 126 programmed to analyze transactions provided in the transaction description data 110 for a given borrower and provide the categorized feature data 112 for the given borrower, such as for further processing as described herein. The data analysis and tagging methods 126 can be programmed clean and normalize descriptions for discrete transactions in the transaction description data 110. For example, the data analysis and tagging methods 126 are programmed to remove special characters, digits and extra spaces. The data analysis and tagging methods 126 can also normalize some words according to a known lexicon, such as by adjusting “pay roll” and “payroll” to a commonly known term. The data analysis and tagging methods 126 includes an income/debt identification function 128, a category tagging function 130 and a feature aggregation function 132.

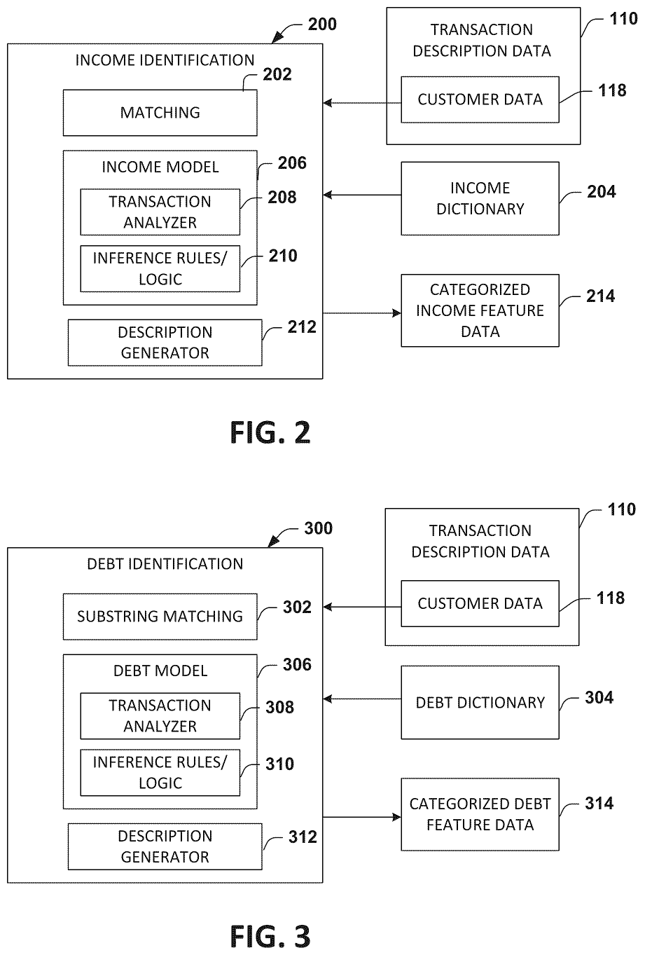

For example, the income/debt identification function 128 is programmed to identify which transactions are representative of income or debt for the borrower and to add or change the description to identify such transactions as debt or income accordingly. As described below, FIGS. 2 and 3 show examples that can be implemented by the data analysis and tagging methods 126 to identify income and debt transactions. The income/debt identification function 128 can be implemented in other ways to identify a borrower's income and debt transactions based on the transaction description data 110.

As an example, FIG. 2 includes an example of an income identification function 200. The income identification function 200 is a useful example that can be implemented by the income/debt identification function 128 to identify and add descriptive metadata to income transactions in the cleaned and normalized version of the transaction description data 110.

In the example of FIG. 2, the income identification function 200 includes a matching function 202 programmed to perform matching of descriptions within the transaction description data 110. The matching function 202 can apply substring, fuzzy or other matching algorithms to match selected parts of borrower information, such as based on customer data 118, and/or terms provided in an income dictionary 204. For example, the matching function 202 is programmed to match an employer's name (e.g., based on customer data 118) in the description of the transaction description data, and the matching function can tag each transaction as income if the employer's name is present in the respective transaction. Such tagging can include writing to or modifying one or more descriptive fields of a transaction record.

The income dictionary 204 can include a set of income-related keywords based on empirical or other studies evaluating numerous income transactions. For example, the income dictionary 204 includes both generic and specific keywords that are present in income transactions. The matching function 202 is thus configured to perform a substring matching and/or fuzzy matching of the keywords from the dictionary with short and long descriptions in the transaction data 110 and to tag respective transactions as income in response to detecting a match. In some examples, the transaction data 110 includes certain fields having generic descriptions, such as ‘memo’, ‘category’ etc. (e.g., added by the aggregator service 116), and the matching function 202 can be programmed to perform the following function:
If (memo column has any substring matching ‘salary’, ‘payroll’, ‘earning’, ‘income’ and ‘fed sal’) AND (category is ‘Paycheck’) AND (transaction amount >190) AND (previous lokyata tag is not [‘Income’,‘Loan Disbursement’,‘Cash Advance’,‘Pay Advance’]) then tag transaction as income.

The income identification function can also include an income model 206. The income model 206 can be implemented as a discriminant model programmed to implement statistical techniques to identify income. For example, the income model 206 is programmed to evaluate transaction amount, frequency of transactions (e.g., weekly, monthly, bi-weekly, uncertain), transaction description, deltas between inferred transaction amounts, span between the dates of transactions with same descriptions and transactional trends (transaction).

In the example of FIG. 2, the income model 206 includes a transaction analyzer 208 programmed to identify income transactions based on a set of income-related inference rules and/or logic 210. The rules 210 can specify a number of one or more prerequisites for income transactions. As an example, a prerequisite can specify a required range of transaction history, such as a minimum period of time used by the income analyzer to identify a transaction as an income transaction. Another prerequisite rule can be the absence of another descriptor identifying the potential income transaction as being another type of transaction (e.g., Loan Disbursement). The rules/logic 210 can also specify the extent to which the descriptions should match (e.g., match the entire descriptions). The inference rules/logic 210 can further specify how the borrower's transaction data is aggregated at the description level to characterize income. Examples of logic/rules 210 that can be implemented by the income analyzer 208 for characterizing income are as follows:
If (transaction amount is in range [750, 7100]) AND (count of transaction for a description is in range [2, 4]) AND (average delta of all the transaction amounts for a description is in range [20, 35]) AND (span between the first and last transaction for a description is in range [20, inf)) then it is income and the income frequency is Monthly;
If (transaction amount is in range [380, 3600]) AND (count of transaction for a description is in range [5, 8]) AND (average delta of all the transaction amounts for a description is in range [10, 19]) AND (span between the first and last transaction for a description is in range [20, inf)) then it is income and the income frequency is Bi-Weekly;
If (transaction amount is in range [190, 1800]) AND (count of transaction for a description is in range [9, 14]) AND (average delta of all the transaction amounts for a description is in range [3, 9]) AND (span between the first and last transaction for a description is in range [20, inf)) then it is income and the income frequency is Weekly'; and
If (transaction amount is in range [190, 7100]) AND (count of transaction for a description is in range [2, inf)) AND (average delta of all the transaction amounts for a description is in range [3, inf)) AND (span between the first and last transaction for a description is in range [20, inf)) then it is income and the income frequency is uncertain,

The income model 206 or another feature of the income identification function 200 can be programmed to infer characteristics about an identified group of income transactions. For example, a borrower can have multiple sources of regular income (e.g., primary, secondary etc. income sources), and income identification function 200 can identify each transaction as being associated with each respective income source accordingly. Additionally, or alternatively, the income identification function 200 can be programmed to infer other characteristics about transactions provided in the data 110, including the number of separate income sources, the payment frequency for each income source and the like. The income identification function 200 can also be programmed to determine an indication (e.g., a normalized stability value) representing income stability for each identified source of regular income. For example, income stability can be determined (e.g., by the income identification function 200) based on an evaluation of inferred income parameters, such as including regularity and span of day of deposits, inferred income value trends, count and value of income sources. In some examples, the income identification function 200 evaluates a comparison between income transactions identified by the matching function 202 and the income model (e.g., by inference) 206.

The income identification function 200 also includes a description generator 212 programmed to provide categorized income feature data 214 that characterizes respective income transactions that have been identified (e.g., by matching and/or by inference). The categorized income feature data 214 can be part of the transaction description data 110 that has been identified as representative of one or more income transactions or include income transactions that have been derived from and generated to represent one or more respective income transactions. For example, the description generator 212 is programmed to write income description information to one or fields of respective transaction records (e.g., in the categorized feature data 112) based on the income matching and/or income model categorizing functions 202, 206 to characterize respective transactions as being representative of income for the borrower.

As another example, FIG. 3 shows an example of a debt identification function 300. The debt identification function 300 is a useful example that can be implemented by the income/debt identification function 128 to identify and add descriptive metadata to debt transactions in the cleaned and normalized version of the transaction description data 110. The debt identification function 300 can be configured to identify debt according to a similar approach as used by the income identification function. For example, the debt identification function 300 includes a debt text matching function 302 and a debt model 306, in which the functions 302 and 306 are programmed to identify and/or infer debt-related transactions in the transaction description data 110. The debt matching function 302 can match descriptions within the transaction description data 110 (e.g., using substring matching, fuzzy matching or other matching algorithms) to match selected parts of the transaction data 110 to borrower-provided information, such as based on customer data 118, and/or terms provided in a debt dictionary 304.

The debt model 306 can be implemented as a discriminant model programmed to implement statistical techniques to infer debt transactions in the transaction description data 110 based on a set of debt-related inference rules and/or logic 310. For example, the debt model 306 includes a transaction analyzer 308 programmed to evaluate transaction amount, frequency of transactions (e.g., weekly, monthly, bi-weekly, uncertain), transaction description, deltas between inferred transaction amounts, span between the dates of transactions with same descriptions and transactional trends (transaction) to infer debt transactions that occur over time. Similar to the income identification function 200, the rules/logic 310 can specify a number of one or more prerequisites for debt transactions, the absence of another descriptor identifying the transaction as another type of transaction (e.g., Income) and the extent to which the descriptions should match (e.g., match the entire descriptions). The inference logic/rules 310 can further specify how the borrower's transaction data is aggregated at the description level to characterize identified debt transactions. The debt identification function 300 can also infer stability or trends indicative of changes in debt transactions over time based on an evaluation of identified debt transactions.

The debt identification function 300 also includes a description generator 312 programmed to provide categorized debt feature data 314 to characterize respective debt transactions and inferred debt characteristics (e.g., parameters). The categorized debt feature data 314 can be part of the transaction description data 110 that has been identified as representative of one or more debt transactions or include debt transactions that have been derived (e.g., inferred) from the transaction data 110 to characterize one or more debt transactions. For example, the description generator 212 is programmed to write debt description information to one or fields of respective transaction records (e.g., in the categorized feature data 112) based on the matching and/or debt model categorizing functions 302, 306 characterizing respective transactions as being representative of debt for the borrower.

Referring back to FIG. 1, the category tagging function 130 can be programmed to process the cleaned and normalized transaction data 110 and add category tags (e.g., category metadata) to respective discrete transactions in the categorized feature data. Examples of some categories of discrete transactions to which the category tagging function can add corresponding category tags include debt settlement, gambling gaming, loan disbursement, loan payment, nonsufficient funds, overdraft protection, pawnshop, pay advance, other expense, transfer, withdrawal and cash advance. Different category tags can be used in other examples. The category tagging function 130 can further include a configuration file, such as a dictionary (not shown) that describes all available categories. The category dictionary can include a set of possible keywords used to perform matching (e.g., substring and/or fuzzy matching) with the description text in the transaction description data 110 and respective credit type configured to tag each of the transactions. While the income/debt identification function 128 is shown in the examples of FIGS. 1-3 as being separate from the category tagging function 130, in other examples, the income/debt identification function 128 can be combined (in whole or in part) with the category tagging function.

The feature aggregation function 132 can be programmed to analyze the cleaned and normalized transaction data 110 and generate new aggregate transaction data based on analysis of multiple transactions (e.g., two or more transactions) in the data 110 and provide corresponding category tags that characterize a meaning or significance of the multiple transactions. The feature aggregation function can be programmed to infer one or more respective categories based on an evaluation of the transaction description data 110. Examples of some categories of aggregate transactions that can be included in the categorized feature data 112 include trended income regularity, trends in income value, trends in debt value, monthly total income, monthly total debt, other summary data and the like, which can be computed and/or inferred from the transaction description data 110. As described herein, the categories used to describe discrete and aggregate transactions represent variables used by a decision analyzer 134 (e.g., variables of a transaction scoring model). In some examples, transactions that are not able to be tagged by the category tagging function 130 or feature aggregation function 132, or otherwise already have been tagged as “other expenses”, a set of other transaction aggregator parameters (e.g., defined by the aggregator service 116) can be used to characterize such transactions. The other transaction aggregator parameters can include category tags such as is_direct_deposit, is_income, is_overdraft_fee to tag ‘Deposit’, ‘Income’, ‘Non Sufficient Funds’ respectively. Different transaction parameters can be used to tag these and other types of untaggable transactions in other examples. If the transaction amount is less than 25$, it is either tagged as “Other Expense” or “Deposit” as per credit type.

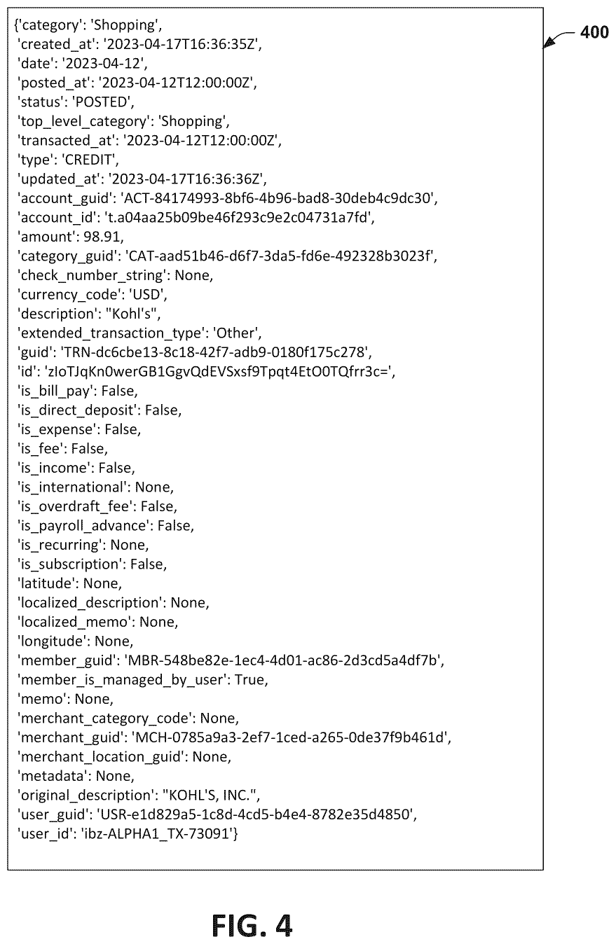

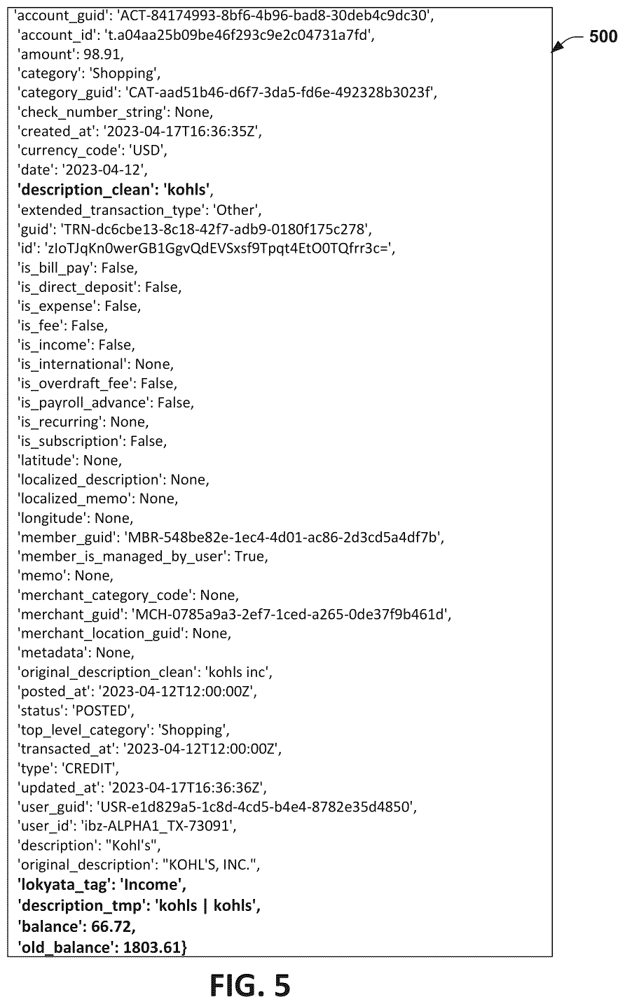

As a further example, FIGS. 4 and 5 represent different versions of transaction data for a respective transaction. FIG. 4 depicts an example of part of transaction description data 110 representing a shopping transaction, shown at 400, that is categorized as type ‘other’. The transaction data 400 thus includes an arrangement of fields, such as representing raw transaction data provided by aggregator service 116. FIG. 5 represents another version of the same transaction data, shown at 500, which is representative of the categorized feature data 112 after the data analysis and tagging function 126 has analyzed and categorized the original (e.g., raw) transaction data 400 of FIG. 4. In the example of FIG. 5, the data analysis and tagging function 126 has added category tags to the original transaction data, such as are shown in bold in the respective fields of the transaction data 500 to accurately categorize the transaction as income where it was originally incorrectly identified as shopping. In other examples, a given transaction in the categorized feature data can include same fields as the original data or different numbers depending on the data analysis and tagging functions that are applied to the transaction data 110. As shown in FIG. 5, the added category tags in the transaction data include a custom tag that is added to characterize the transaction record as being indicative of income for the borrower. The added category tags in the transaction data also include balance tags, including ‘balance’ and ‘old balance’ tags, each of which includes a value, such as can be derived (e.g., inferred) from an analysis of the amounts in the current transaction and one or more other transactions. Those skilled in the art will understand that other information can be determined and written to a given transaction data record based on this description.

The decision analyzer 134 is programmed to generate one or more scores and/or other decision data, shown at 136, based on the categorized feature data 112. The decision analyzer can use a combination of discriminant modeling and machine learning to provide the scores/decision data 136. For example, each of the scores and decision data 136 can include an indication of a credit worthiness (or lack thereof) for the borrower. The decision analyzer 134 can generate the score and/or other decision data 136 automatically or in response to a user input instruction to generate such data. As shown in the example of FIG. 1, the decision analyzer 134 includes rules 138 and one or more scoring models 140, which are applied to the categorized feature data 112 to provide score/decision data 136.

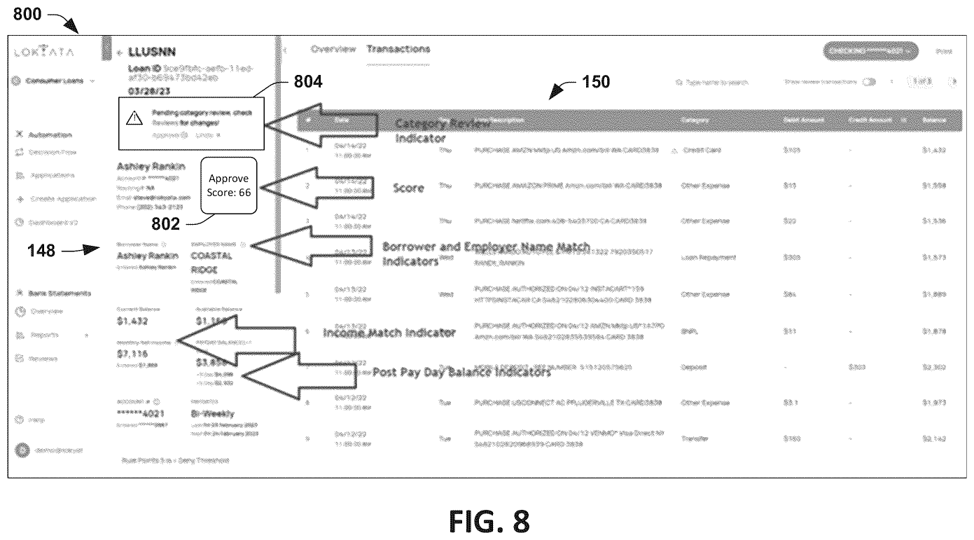

The TASS 102 also includes an output generator 144 configured to provide an interactive output 146, which includes one or more graphical representations based on the categorized feature data 112 and the score/decision data 136. For example, the output generator 144 includes a score/decision GUI 148 and a transaction/feature GUI 150, which can be provided as part of or within the interactive output 146. The interactive output 148 can be presented (e.g., using a markup language) at one or more of the user stations 106 through a secure communication link through the network 104 (shown schematically by dotted line 152). As described herein (see, e.g., FIGS. 8-17), one or more authorized users can interact with respective GUI elements of the GUIs 148 and 150 through respective I/O devices 120. The score/decision GUI 148 includes GUI elements programmed to review, approve or reject decision recommendations and/or the underlying score/decision data 136. The transaction/feature GUI 150 includes GUI elements programmed to view, modify and/or approve changes made to features in the categorized feature data 112 responsive to user input instructions (e.g., entered using I/O devices).

In an example, the TASS 102 also includes a rule generator 142 programmed to define one or more of the rules 138. The rule generator 142 can include a GUI that enables an authorized user (e.g., an administrator or other individual) to configure a number of rules 138 responsive to user input instructions (e.g., entered through I/O devices 120 at the user station 106). For example, the rule generator 142 is configured to provide the rules 138 to encode a set of underwriting rules for a given lender that are applied to the categorized feature data 112 to determine a first hierarchical decision that indicates whether or not a loan should be granted to a borrower. Once established, the rules 138 can be fixed or one or more rules can be modified (e.g., added, deleted or changed), such as through the rule generator 142. There can be any number of rules.

As an example, each rule 138 includes a transaction variable, an operator, one or more respective conditions (e.g., threshold or value). Each rule 138 can also be assigned a weight value, which is output by the rule if the rule is active and the rule condition is satisfied. For example, each rule 138 can be assigned a weight value by assigning a number of points (e.g., a positive or negative value) to each respective rule, such as specified in response to a user input entered by an authorized user through the rule generator 142. The transaction variables in each rule 138 can be representative of or map to category tags in the categorized feature data 112. A transaction variable thus can represent a discrete transaction or an aggregate (e.g., inferred or computed) transactional feature that is derived from an evaluation of multiple discrete transactions, such as may occur over an extended period of time (e.g., weeks, months or years). The operators can include Boolean operators, comparative operators, logic operators or other operators (e.g., combinatorial operators), such as to compare and/or otherwise evaluate values of respective variables specified in the categorized feature data 112. Each of the rules 138 can be determined independently from other rules or, in some examples, one or more rules can be configured to be interdependent on the outcome of one or more other rules.

Each of the rules can allocate a number of specified points to a rule point total in response to the respective rule condition(s) being met based on the categorized feature data 112. For example, points from each of the active rules having met its respective rule condition can be summed together to provide the rule point total. The rules 138 further can be configured to compare the rule point total to a total point threshold (e.g., a deny threshold), which also can be set in response to a user input entered through the rule generator 142. For example, if the rule point total resulting from active rules 138 exceeds the point threshold, the first hierarchical decision can instruct the user (e.g., lender) to deny a loan to a given borrower. If the rule point total does not exceed the point threshold, the first hierarchical decision can enable further consideration and processing by the decision analyzer 134. In some examples, a user can deny a borrower in response to entering a user input instruction to deny a loan regardless of the first hierarchical decision.

As one example, each of the rules 138 is weighted, and assigned an integer value between 0 and 10. For instance, a value of 0 has no weight and thus does not contribute to the first hierarchical decision. In some examples, however, activating a rule having a point value of zero causes the output generator 144 to include a GUI element, such as a scorecard, in the interactive output 146 to visualize the category tag description and the value associated with the category tag from the data 112. This advantageously affords a user the ability to review meaningful data that might not be included in the requisite underwriting criteria, as encoded by the rules 138 that are combined to provide the first hierarchical decision.

As an example, the decision analyzer 134 is programmed to compute a decision score based on applying the scoring model 140 to the categorized feature data 112. As described herein, the categorized feature data 112 includes category tags for discrete transactions and values for respective category tags, which can be from a discrete transaction or be derived from an evaluation of multiple transactions (e.g., a summaries, key performance indicators, totals, transaction trends, stability indicators, balances, etc.) as described herein. The category tags and associated values correspond to model variables used in the scoring model 140 to provide one or more scores and/or other decision data.

As an example, the scoring model 140 is implemented as a machine learning algorithm programmed to determine an aggregate score. The scoring model 140 can include a plurality of scoring modules that are trained, collectively, to provide the aggregate score for a borrower based on processing the categorized feature data 112. Examples of individual scoring modules include an eligibility criteria module, a pay day & transaction seniority module, income structure & income trends module, a debt disbursements module, a non-sufficient funds module, a debt-service (e.g., existing debt) module, a cash flow module, and an account balance module.

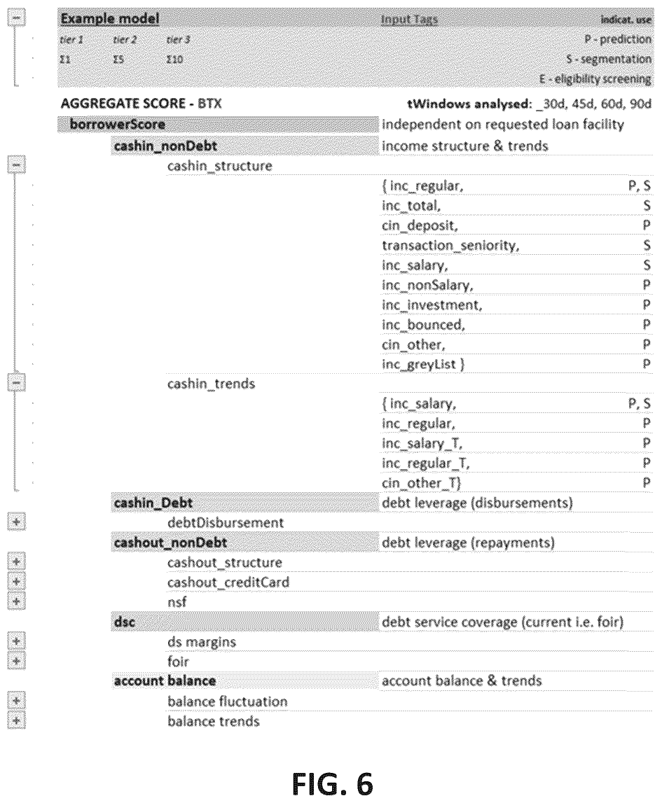

As a further example, the scoring model 140 can be implemented as a multi-tiered model structure, such as including a respective set of transaction category tags and related subcategories selected for use characterizing transaction features pertaining to each respective module. The transaction category tags for each module can vary depending on the predictive outcome the respective module is being trained to determine, and there can be multiple levels within each category tag. As shown in the example of FIG. 6, an aggregate score for a borrower an example, a cash-in structure module can include multiple sub-categories levels for characterizing different cash-in features of a borrower's cash-in transactions, such as to including regular income, total income, cash-in deposits, etc. Other modules of the scoring module can be structured in a similar manner to that shown in FIG. 6.

Each module further includes a number of model variables, each of which in turn combines a number of unique variable inputs (e.g., referred to as ‘variable attributes’) that have been created by summarizing different transaction category tags in the feature transaction data 112. Each model variable thus includes model variables inputs and outputs. Each model variable input has a number (e.g., one or more) of attribute values, and each model variable output can specify a risk rank.

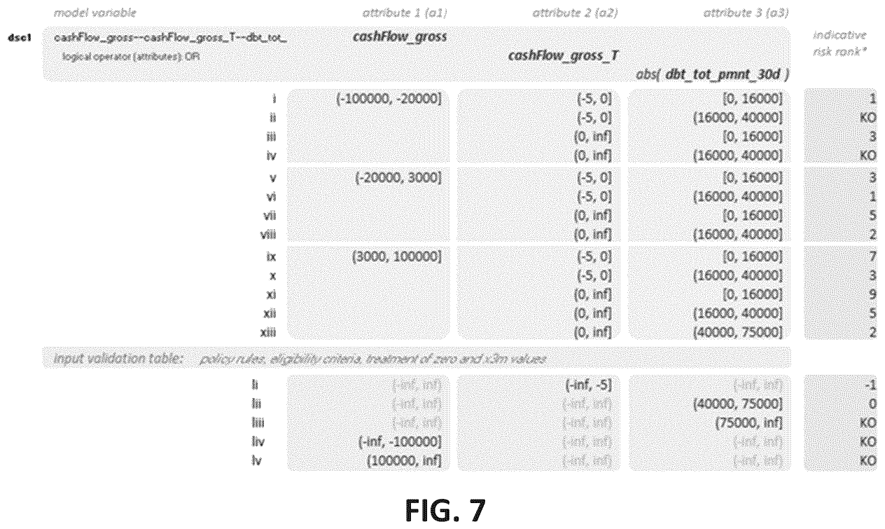

As one example, FIG. 7 shows an example of model variable ‘dsc1’ that includes a risk-ranking section (e.g., labeled with Roman numerals T to ‘xiii’) and an input-validation section (e.g., labeled li’ to ‘lv’). The risk ranking section can employ a risk scale (e.g., ranging from 1 to 9), in which 1 represents the highest credit risk and 9 represents the lowest credit risk. A knockout (KO) can be used for an automatic rejection (e.g., denial) of a loan application. Each variable thus can output a single risk rank value or ‘KO’. If application is not rejected by ‘KO’ risk rank (a single ‘KO’ suffices for rejection), then risk rankings for individual model variables can be combined by using a model weighting system, which results in providing a final model score (e.g., in the scoring/decision data 136). Each model variable can be assigned a weight as a fraction (or percentage) of all weights, which together add up to 100%. Other configurations of model variables can be used in other examples.

As a further example, variable classes of the risk ranking section can be defined statistically to maximize discriminant power of the model variables, whereas classes of the validation sections can be created to treat extreme values for the variable inputs. Together, the risk ranking and validation sections can cover the whole range of values for each variable input. A column labeled ‘indicative risk rank’ is configured to assign risk rankings to individual variable classes, such as by using discriminant technique based on measuring bad rate for the class and total size of each class. As part of the model training, such as described herein, risk rankings can be evaluated for each class of every model variable, reviewed by subject matter experts (e.g., a model developer and an underwriting expert working together) to help ensure that each underwriting interpretation for each class comply with the general underwriting principles. Minor expert adjustments to risk rankings can be made based on such evaluation/review. After any expert adjustments are carried out, the model is re-tested to evaluate the impact of adjustments. In the example of FIG. 7, columns entitled ‘attribute 1’ (a1), a2 (in this case a feature called ‘gross cash flow_trend’) and a3 are examples of variable inputs or ‘attributes’. Logical operator between attributes can be ‘AND’. As an example, class T can be interpreted as follows:
IF a scored input value (a scoring request) for al is in the range defined as (−100000, −20000) AND a2=(−5, 0] AND a3=[0, 16000] THEN ‘dsc1’ is assigned risk ranking output ‘1’ for such scoring request.

The scoring model 140 (e.g., machine-readable instructions executable by a processor) thus includes a machine learning model trained based on a set of training data for respective borrowers having known loan outcomes. The training, which can include feature tagging, can be applied globally for a number of lenders or separately for each respective lending institution. The scoring model 140 thus can be configured to process categorized feature data consistent with how the model is trained to identify respective categorized features known to be predictive of a desired loan outcome, such as a borrower making at least a minimum number of loan payments. Similar to as described herein, the training data is analyzed and tagged to include a respective categorized and tagged feature data. The tagging can include automated feature tagging and/or manual tagging determined by a subject matter expert. The training process is designed to adjust one or more of feature sensitivity and feature sensitivity as well as to minimize the number of good loan rejections and maximize the number of bad loan rejections. The model training can also create and adjust the weighting applied to various model variables, which represent respective category tags, such that the resulting scoring model 140 includes a machine learning scoring model optimized to achieve (e.g., predict) the desired loan outcome.

As a further example, the decision analyzer 134 is configured to combine weighted rules (e.g., used for simply deny criteria) 138 with one or more scoring models 140 to provide one or more decision GUIs 148 in the interactive output 146. For example, if a deny rule threshold applied by the rules is not met, then the score produced by the scoring model 140 is evaluated against one or more respective thresholds (e.g., approve and/or deny thresholds). In a scenario when the score (e.g., as computed by the machine learning scoring model 140 for a given loan application) falls between deny and approve thresholds, then score/decision GUI 148 can be programmed to flag the application for manual review by a user (e.g., an agent or other lender personnel).

In some examples, user input instructions are entered at the user station 106 using GUI elements of the transaction/feature GUI 136 to modify one or more category tags for a feature (e.g., a discrete transaction or aggregated transactions) in the categorized feature data 112. In response to changing one or more category tags, the decision analyzer 134 is programmed to re-generate each score and/or other decision data 136, such as by applying the rules 138 and scoring model 140 to the modified categorized feature data 112.

FIGS. 8-17 depict examples of GUIs that can be provided by the output generator 144. The examples of FIGS. 8-17 demonstrate useful examples of the score/decision GUI 148 and transaction/feature GUI 150 that can be provided in the interactive output 146 and displayed on a display (e.g., the I/O device 120) at one or more user stations 106. The examples of FIGS. 8-17 also show example workflows that a user can implement in connection with reviewing and making decisions on a number loan applications based on this disclosure. While the examples of FIGS. 8-17 include various types of GUI elements for entering data and configuring rules, different GUI elements can be used in other examples.

For example, FIG. 8 depicts an example of a GUI 800 configured to provide an overview of decision results and categorized feature data. The GUI 800 is annotated to show examples of decision and score indicators, which can be provided by the score/decision GUI 148, to specify how the decision was made by either rules or score. The GUI 800 also includes a decision GUI element 802 programmed to provide a score and provide a recommendation (e.g., to approve) the loan application based on the score (e.g., determined by the decision analyzer 134). For example, a user can activate the decision GUI element 802 responsive to a user input selecting the GUI element (e.g., a radio button or other GUI feature) to accept the recommendation and approve the loan application. The GUI 800 also includes a category review GUI element 804, which can be provided by the transaction/feature GUI 150, such as in response to a change in one or more category tags. Activation of the category review GUI element 804 can open a review page (or window), such as disclosed herein where an authorized user can accept or reject the change(s). The decision GUI element 802 can be color coded depending on the recommendation (e.g., green—approve, yellow—review, red—deny). Other colors could be used in other examples.

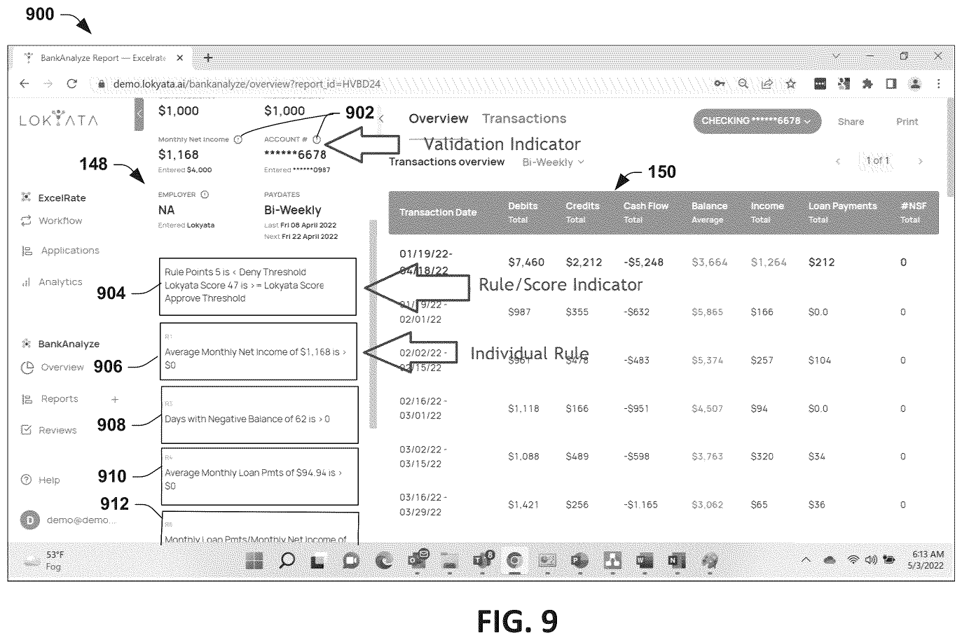

As a further example, FIG. 9 depicts an example GUI 900 programmed to provide respective indicators for each verifiable data point where loan application data is matched to data points found in the bank account transactions. The GUI 900 can also include a rule/score indicator GUI element (e.g., in the form of a rule card GUI feature), shown at 904-912 for visualizing descriptors and results for respective rules 138. Each of the rule/score indicator GUI elements 904-912 can be implemented as graphical rule cards that are displayed for each active rule and be encoded to specify whether or not a rule condition (e.g., threshold) has been met. The rule/score indicator GUI elements 904-912 can also include colors (e.g., colors green, yellow, red) and/or other graphical features to indicate recommended decision, as determined by respective rules 138.

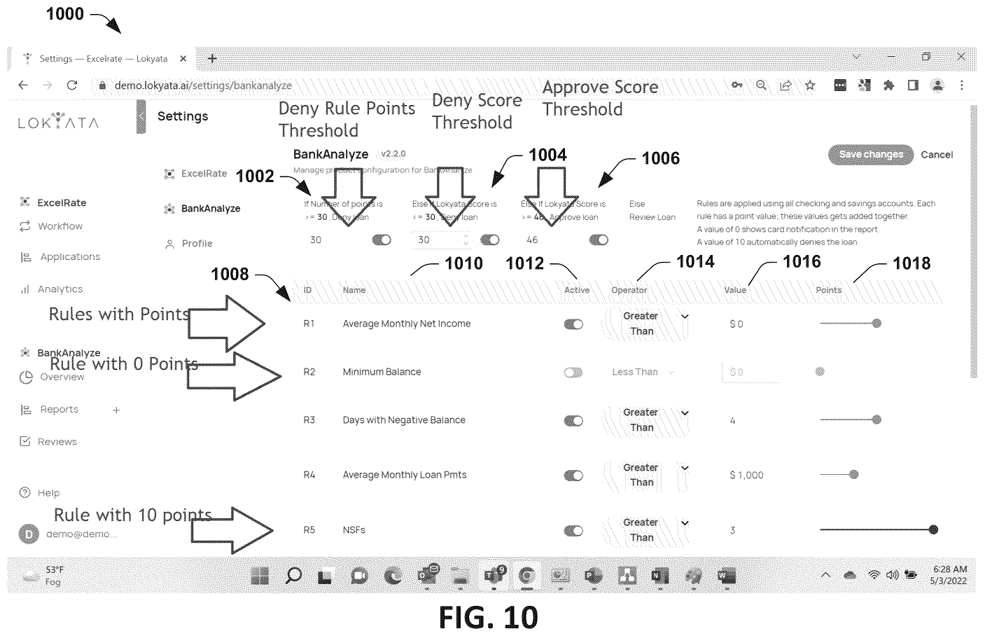

FIG. 10 is an example of GUI 1000 programmed to use the rule generator 142 to configure one or more of the rules 138. The GUI 1000 can be a credentialed tool that requires authentication by an authorized user, such as an administrator manager or the like. The GUI 100 includes an arrangement of GUI elements 1002, 1004 and 1006 programmed to set respective thresholds used by the decision analyzer to determine a recommendation for denying or approving a loan application. For instance, the GUI element 1002 is used to set a rule points threshold for denying a loan application, such as based on the summed rule points determined by the active rules 138 based on the categorized feature data 112. The GUI element 1004 can be used to set a deny score threshold, responsive to a user input at 120, for recommending denying a loan application, such as based on score determined by applying the scoring model 140 to the categorized feature data 112. The GUI element 1006 can be used to set an approved score threshold for recommending approval of a loan application, such as based on score determined by applying the scoring model 140 to the categorized feature data 112. Each of the rules can also include an activation to enable or disable the respective threshold. If a computed score falls between Deny and Approve score thresholds, then the score decision GUI 148 can be programmed to set a flag for manual review by a user (e.g., lender personnel), such as shown at 804 in the GUI 800 of FIG. 8.

The example GUI 1000 of FIG. 10 also includes a plurality of rules 1008, of which rules R1-R5 are shown. There can be any number of rules 1008. The GUI 1000 includes GUI elements 1010-1012 to enable each of the rules to be configured by an authorized user(s). The GUI element provides a descriptive name for the category tag, which can be selected by a user in response to a user input for a respective rule. More than one rule can use the same category tag. The GUI element 1012 (e.g., shown as a toggle switch) can be used to selectively enable or disable each rule in response to a user input. The GUI element 1014 (e.g., shown as a drop down menu) is configured to select an operator (e.g., a comparative operator, such as <, > or =) in response to a user input that is applied to a value, such as entered at GUI element 1016 (e.g., in a text box). Various types of operators and values can be used for a given rule, which can depend on application requirements and the category tag (or tags) to which the given rule is being applied. The GUI element 1018 (e.g., shown a slide) is configured to assign a point value to each of the respective rules. As described herein, in some examples, the point values can range from 0 to 10, where 10 is a KO resulting in automatic denial. A 0 value can be used to include a rule card GUI element in a GUI, and provide the value for the category tag, but to not include the rule in calculating the rules point total score.

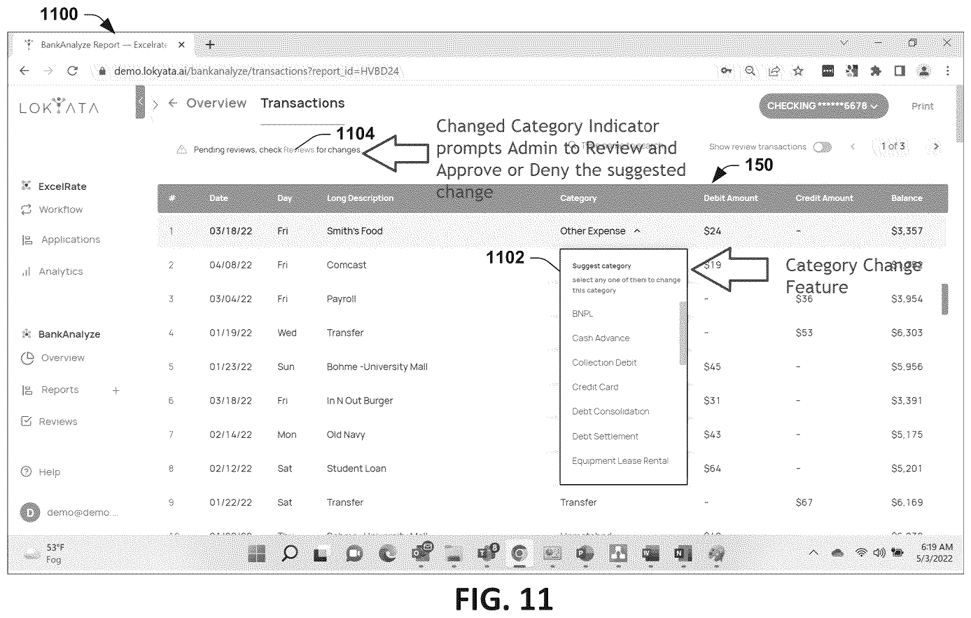

As a further example, FIG. 11 depicts a transaction GUI 1100 that can be generated (e.g., by transaction/feature GUI 150 of output generator 144) for changing one or more category tags of the categorized feature data 112. For example, the GUI 1100 includes a GUI element (e.g., a drop-down menu) 1102 that displays a set of potential replacement category tags. The transaction/feature GUI 150 can be programmed to suggest one or more alternate category tags for a selected transaction, such as in response to a request issued to one or more of the data analysis and tagging methods 126. In the example of FIG. 11, the current category tag for the selected transaction is ‘other expense’ and the GUI element 1102 provides a list of alternate category tags that the user can choose for the selected transaction in response to a user selection input (e.g., through I/O device 120) at the user station 106.

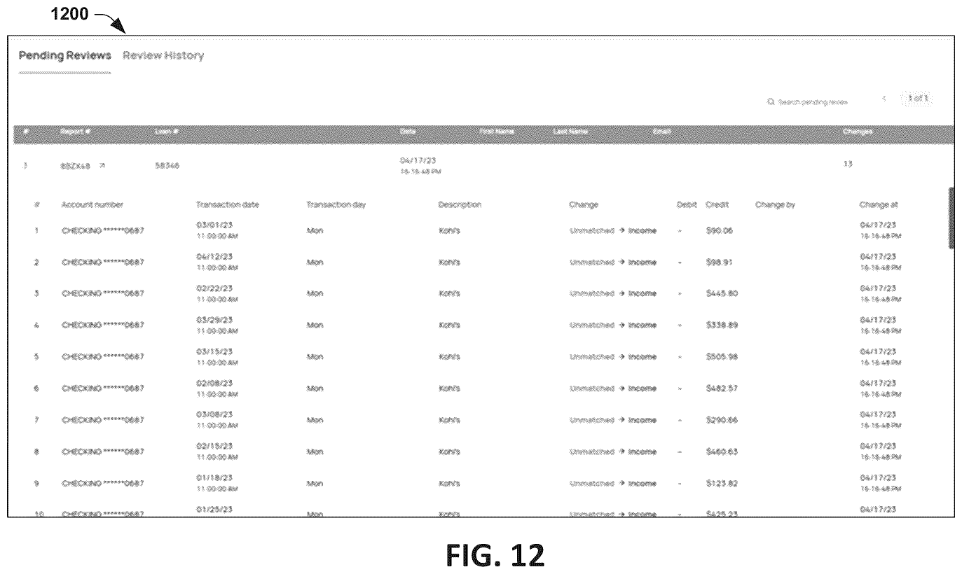

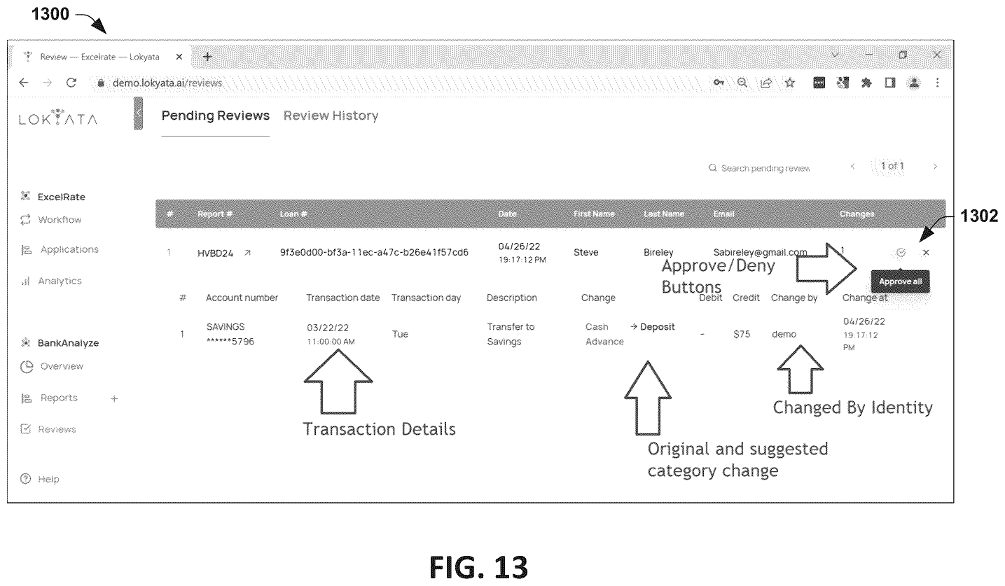

In response to changing one or more category tags in the categorized feature data 112, the modified tag can be stored in the categorized feature data 112 for the respective loan application. The transaction/feature GUI 150 or another function can be further be programmed to display another GUI element 1104 on the GUI 1100 to indicate that one or more category tags have been changed and are pending review. In some examples, changes to tagged transactions are reviewed and either approved or rejected by an authorized user (e.g., loan officer, admin, or manager) in response to a user input instruction to approve or reject the category change, such as shown in respective GUIs of FIGS. 12 and 13. Once approved, responsive to a user input by the authorized user, the approved changes are stored in the borrower's categorized feature data 112. In an example, additional metadata for documenting each change can be stored in the respective transaction record, such as specifying the original category tag, the modified category tag, the date of the change and user identity (e.g., who made and approved the change). Additional notes, comments or other relevant information can also be stored associated with change information.

In response to category change (or any other change to data analysis and tagging methods, the rules and/or model), the decision analyzer can be programmed to reprocess transaction data, such as by applying the rules 138 and scoring model(s) 140 to the modified categorized feature data 112. The reprocessing can be implemented while the change(s) are pending, such as to enable the user to test one or more possible category changes and receive real-time (or near-real time) feedback to visualize updated decision analysis results based on the changes. Alternatively, the reprocessing can be triggered responsive to approval by an authorized user. For example, one or more authorized users can be alerted of the change(s) pending review by alerting each user, such as by sending a notification (e.g., an email message, a text message, an instant message or the like). The notification can include a link (or other means) to access a GUI to review and approve/deny the pending change(s).

Additionally, instances of category tag changes can be sent to a platform service (e.g., a cloud based service or other central repository) for review an inclusion in future category dictionaries and use by data analysis and tagging methods 126 (e.g., income/debt identification functions and/or category tagging functions. As a result, category changes by one lender can be used on a global scale, advantageously enabling crowd sourcing to improve scoring accuracy of the TASS 102.

FIG. 12 depicts an example GUI 1200 that includes a list of pending category tag changes that have been entered by one or more users and are pending review and approval (or rejection) by an authorized user. The approval can be entered in response to a user input using I/O device(s) 120. The GUI 1200 can be accessed, for example, in response to selecting a review GUI element (e.g., GUI element 1104 in FIG. 11). In the example of FIG. 12, the GUI includes data describing the transaction and circumstances associated with the category change.

FIG. 13 depicts an example GUI 1300 that includes an interactive list describing one or more category tag changes pending review for a respective loan application. The GUI 1300 is annotated to identify additional information in the GUI, such as describing transaction details, the original and modified category tag for each transaction listed and the identity of the user making the pending change. The GUI 1300 can include approve/deny GUI elements (e.g., shown as buttons), which can be color coded. The GUI 1300 can also include one or more GUI elements 1302 that can be selected to approve one or more (e.g., approval all) pending changes or to reject (e.g., cancel) the pending changes. The GUI 1300 can be configured to deny or approve pending changes in bulk or one at a time. The instructions entered by the authorized user to approve or reject the pending category changes can also be recorded as change metadata and stored as part of the transaction record.

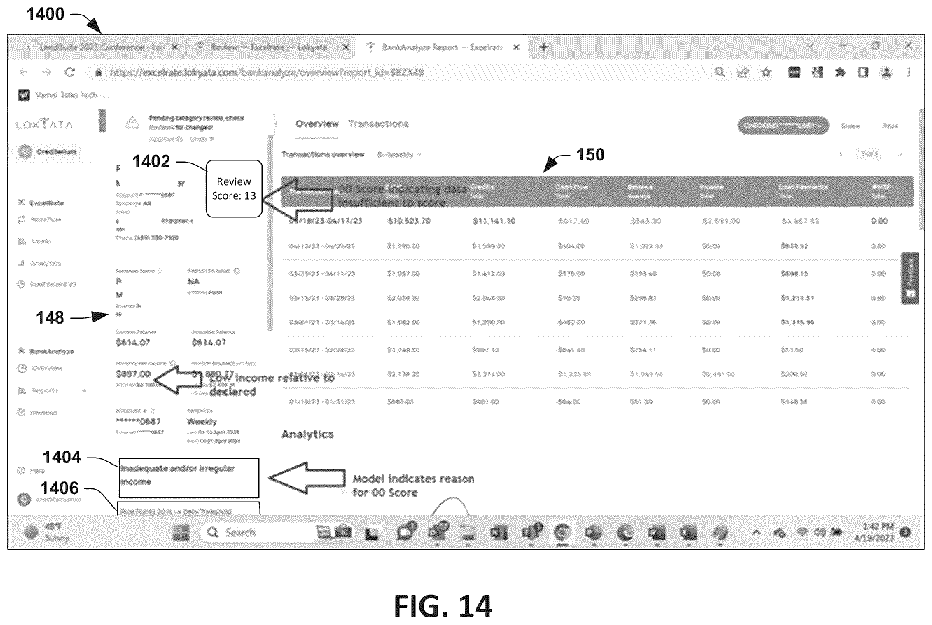

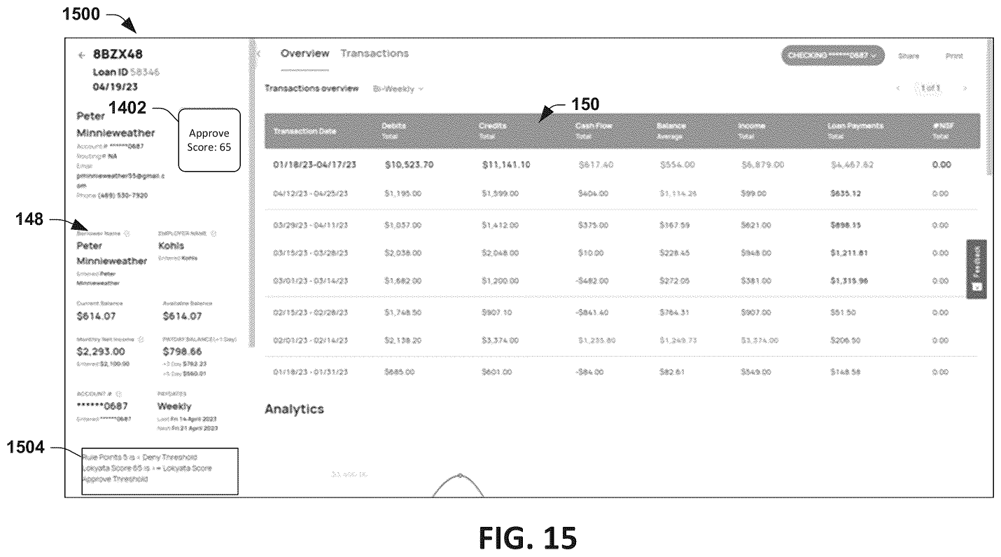

FIGS. 14 and 15 show examples of GUIs 1400 and 1500, respectively, configured to provide an overview of decision results and categorized feature data 112. The example GUI 1400 of FIG. 14 shows decision results and associated feature data, such as generated originally automatically by the data analysis and tagging methods 126. The GUI 1400 displays information provided by the score/decision GUI 148 and by the transaction/feature GUI 150. Additionally, the GUI 1400 is annotated to highlight examples of decision and score indicators, such as to show how the decision was made. For example, the GUI 1400 also includes a decision GUI element 1402 programmed to provide a score and provide a recommendation (e.g., to review) the loan application based on the score (e.g., determined by the decision analyzer 134). The GUI 1400 can also include a number of rule/score indicator GUI elements (e.g., in the form of a rule card GUI feature), shown at 1404 and 1406, for visualizing descriptors and results for respective rules 138 that have been applied.

The example GUI 1500 shows decision results and associated feature data responsive to changes that have been made to one or more category tags, such as described herein. Similar to FIG. 14, the GUI 1500 displays information provided by the score/decision GUI 148 and by the transaction/feature GUI 150. Additionally, the GUI 1400 also includes a decision GUI element 1402 programmed to provide a score and provide a recommendation (e.g., to approve) the loan application based on the score (e.g., determine by the decision analyzer 134 based on the updated feature transaction data 112). The GUI 1500 can also include one or more rule/score indicator GUI elements (e.g., in the form of a rule card GUI feature), shown at 1504, for visualizing descriptors and results for respective rules 138 that have been applied. A comparison between GUIs 1400 and 1500 demonstrates the impact of enabling users to change category tags for respective transactions, which can mean the difference between approving or denying an otherwise deserving individual a loan.

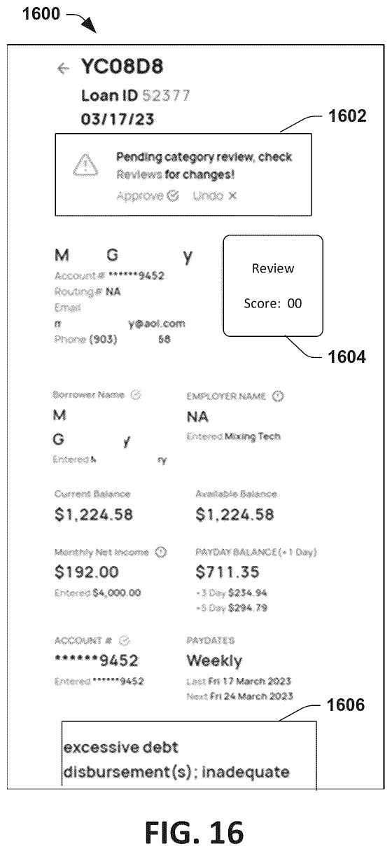

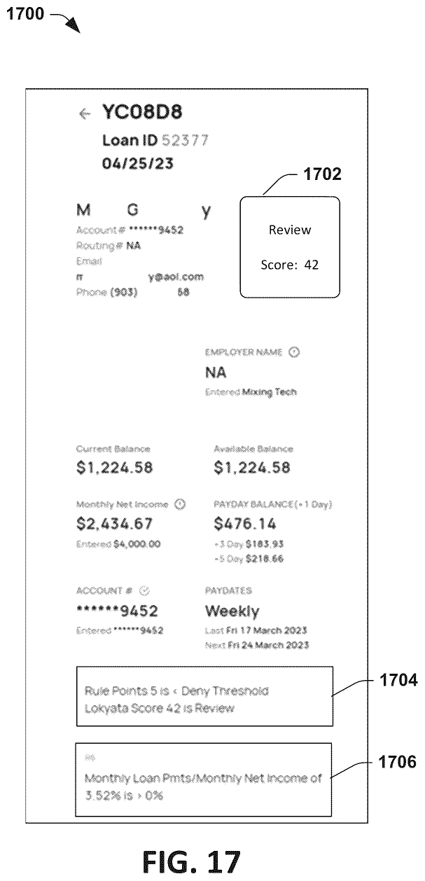

FIGS. 16 and 17 show further examples of GUIs 1600 and 1700, respectively, configured to provide an interactive visualization of score/decision data 136 that can be generated by the decision analyzer before and after modifying category tags for one or more transactions in the same transaction data. The example GUI 1600 of FIG. 16 includes a GUI element 1602 programmed to provide a score and provide a recommendation (e.g., to review) the loan application based on the score (e.g., determined by the decision analyzer 134). The example GUI 1600 represents a condition while one or changes to category tags are pending review, as indicated in GUI element 1602. The GUI 1600 can also include a number of rule/score indicator GUI elements (e.g., in the form of a rule card GUI feature), shown at 1606, for visualizing descriptors and results for respective rules 138 that have been applied (e.g., excessive debt disbursements), which contribute the decision recommendation shown at 1602.

The GUI 1700 represents score/decision data 136 that can be generated by the decision analyzer after the modified category tags have been approved and processed. The example GUI 1700 includes a GUI element 1702 programmed to provide a score and provide a recommendation (e.g., to review) the loan application based on the score (e.g., a score of 42 as determined by the decision analyzer 134 based on the modified feature transaction data 112). The GUI 1700 can also include a number of rule/score indicator GUI elements (e.g., in the form of a rule card GUI feature), shown at 1704 and 1706, for visualizing descriptors and results for respective rules 138 that have been applied. For example, the monthly net income prior to approving the category change was $192.00, and after the category change, the monthly net income increased to $2,434.67. The decision score, shown in GUI element 1702, also increased from 00 to 42 based on the category tag changes. Thus, while the updated decision GUI element 1702 still recommends manual review by the lender, the indicators provided in the GUI 1700 enable a more informed and accurate decision.

In view of the foregoing, the systems and methods disclosed herein enable financial health analysis, summary, and scoring. The approach herein is more predictive than bureau scores for millions of borrowers, resulting in potentially lower interest rates and higher loan amounts. The systems and methods disclosed herein can automate funding decisions based on borrower cash flow, affordability, which can be ascertained through AI-driven behavior analytics. The examples described herein are particularly useful for subprime lending (also referred to as near-prime, subpar, non-prime, and second-chance lending).

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims.

Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

While particular details of various example embodiments have been described, it is understood that the embodiments can be practiced without these specific details. For example, physical components can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although the diagram can describe the operations as a sequential process, many of the operations can be performed in parallel or concurrently. In addition, the order of the operations can be re-arranged. A process is terminated when its operations are completed but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine-readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

In this description, the term “couple” or “couples” means either an indirect or direct connection. Thus, if a first device couples to a second device, that connection may be through a direct connection or through an indirect connection via other devices and connections. For example, if device A generates a signal to control device B to perform an action, then: (a) in a first example, device A is coupled to device B; or (b) in a second example, device A is coupled to device B through intervening component C if intervening component C does not alter the functional relationship between device A and device B, so device B is controlled by device A via the control signal generated by device A.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor wafer and/or integrated circuit (IC) package) and may be configured to couple to at least some of the passive elements and/or the sources to form the described structure, either at a time of manufacture or after a time of manufacture, such as by an end user and/or a third party.

The recitation “based on” means “based at least in part on.” Therefore, if X is based on Y, X may be a function of Y and any number of other factors.

Modifications are possible in the described embodiments, and other embodiments are possible, within the scope of the claims.

What is claimed is:

1. One or more non-transitory machine-readable media including data and instructions executable by one or more processors to perform a method, the method comprising:
accessing transaction description data associated with a borrower, in which the transaction description data includes information describing a plurality of financial transactions of the borrower over at least one time interval recorded by at least one financial institution;
generating feature data based on categorizing and tagging respective transactions in the transaction description data, in which the feature data includes category tags specifying respective categories of discrete features and aggregated features for each transaction, each category tag defines a respective variable of a scoring model, and each respective variable has at least one value representative of a respective discrete or aggregated feature based on the transaction description data;
applying rules to the feature data to provide a first hierarchical decision, in which the rules describe a set of underwriting criteria and the first hierarchical decision represents an automatic denial or enabling further processing by the scoring model; and
applying the scoring model to process the feature data and compute a score having a value representing a credit worthiness and/or a likelihood of loan default by the borrower and providing a second hierarchical decision.

2. The media of claim 1, wherein the method further comprises:
generating a graphical user interface (GUI) including an arrangement of indicator GUI elements based on at least one of the feature data, applying the rules, and/or applying scoring model.

3. The media of claim 2, wherein the indicator GUI elements include a rule card GUI element for at least one rule having a visualization representative of whether or not a threshold for the at least one rule is satisfied.

4. The media of claim 2, wherein the indicator GUI elements include a decision GUI element providing a visualization based on the score, the instructions further programmed to store data representative of an approval or a denial for a loan request responsive to a user input selecting the decision GUI element.

5. The media of claim 2, wherein the indicator GUI elements include a flag GUI element to indicate a category tag has been modified or no category tag has been assigned to characterize a given transaction.

6. The media of claim 1, wherein generating the feature data further comprises:
modifying at least one category tag for a respective transaction represented in the feature data, responsive to a user input, to provide modified feature data; and
re-applying the rules and the scoring model based on the modified feature data.

7. The media of claim 6, wherein re-applying the rules and the scoring model is implemented automatically in response to the modifying or a user input instruction to approve the modified feature data, and the method further comprises generating a graphical user interface (GUI) including an arrangement of indicator GUI elements based on re-applying the rules and the scoring model.

8. The media of claim 1, wherein the method further comprises:
generating a graphical user interface (GUI) including an arrangement of GUI elements, a category change indicator GUI element being provided to indicate a pending change to the category tag requires user approval.

9. The media of claim 8, wherein the method further comprises:
storing data representative of an acceptance of the change to the category tag responsive to a user input approving the change to the category tag; and
deleting the data representative of an acceptance of the change to the category tag responsive to a user input rejecting the change to the category tag.

10. The media of claim 9, wherein the method further comprises:
evaluating the modified at least one category tag; and
updating the scoring model based on the evaluation of the modified at least one category tag.

11. A system, comprising:
one or more non-transitory machine-readable media storing data and instructions;
one or more processors configured to access the media and execute the instructions to perform a method comprising:
generating feature data based on categorizing and tagging respective transactions in transaction description data, in which transaction description data includes information describing a plurality of financial transactions of a borrower over at least one time interval recorded by at least one financial institution, the feature data includes category tags specifying respective categories of discrete features and aggregated features for each transaction, at least one category tag defines a respective variable of a scoring model, and each respective variable has at least one value representative of a respective discrete or aggregated feature based on the transaction description data; and
analyzing the feature data by at least one of:
applying rules to the feature data to provide a first hierarchical decision, in which the rules describe a set of underwriting criteria and the first hierarchical decision represents an automatic denial or enabling further processing by the scoring model; and
applying the scoring model to process the feature data and compute a score having a value representing a credit worthiness and/or a likelihood of loan default by the borrower.

12. The system of claim 11, further comprising:
a user station coupled to the processor for displaying a graphical user interface (GUI), the processor further including instructions programmed to generate the GUI to include an arrangement of indicator GUI elements based on the feature data, applying the rules, and/or applying scoring model.

13. The system of claim 12, wherein the indicator GUI elements include a rule card GUI element for at least one rule having a visualization representative of whether or not a threshold for the at least one rule is satisfied based on the feature data.

14. The system of claim 12, wherein the indicator GUI elements include a decision GUI element providing a visualization based on the score, the instructions further programmed to store data representative of an approval or a denial for a loan request responsive to a user input selecting the decision GUI element.

15. The system of claim 12, wherein the indicator GUI elements include a flag GUI element to indicate one or more category tag has been modified or no category tag has been assigned to characterize a given transaction.

16. The system of claim 11, wherein the processor further includes instructions programmed to:
modify at least one category tag for a respective transaction represented in the feature data, responsive to a user input, to provide modified feature data; and
re-apply the rules and the scoring model based on the modified transaction and feature data.

17. The system of claim 16, wherein re-applying the rules and the scoring model is implemented automatically in response to the modifying or responsive to a user input instruction to approve the modified transaction, and the processor further includes instructions programmed to generate a graphical user interface (GUI) including an arrangement of indicator GUI elements based on the re-applying the rules and/or the scoring model.

18. The system of claim 11, wherein the instructions are further programmed to:
generate a graphical user interface (GUI) including an arrangement of GUI elements, a category change indicator GUI element being provided to indicate a pending change to the category tag requires user approval.

19. The system of claim 18, wherein the instructions are further programmed to:
store data representative of an acceptance of the change to the category tag responsive to a user input approving the change to the category tag; and
deleting the data representative of an acceptance of the change to the category tag responsive to a user input rejecting the change to the category tag.

20. The system of claim 19, wherein the instructions are further programmed to:
evaluate the modified category tag; and
updating the scoring model based on the evaluation of the modified one category tag.
